(19) United States
(12) Patent Application Publication
(10) Pub. No.: US 2008/0202784 A1
(43) Pub. Date: Aug. 28, 2008

(54) Hand-Held Power Tool

(76) Inventors: Peter Stierle, Waldenbuch (DE); Albrecht Hofmann, Steinenbronn (DE); Juergen Wiker, Leinfelden-Echterdingen (DE); Mario Pauli, Gundeisheim (DE); Stefan Heess, Leinfelden-Echterdingen (DE); Thomas Schomisch, Filderstadt (DE); Meinhard Eule, Aichtal (DE)

Correspondence Address: MICHAEL J. STRIKER, 103 EAST NECK ROAD, HUNTINGTON, NY, 11743, US

(21) Appl. No.: 11/568,888

(22) PCT Filed: Feb. 13, 2006
(86) PCT No.: PCT/EP2006/050868

§ 371 Date: Mar. 3, 2008

(30) Foreign Application Priority Data
Apr. 11, 2005 (DE) 102005016453.6

(51) Int. Cl. B25D 17/24

(52) U.S. Cl. 173/162.1

(57) ABSTRACT

The present invention relates to a portable power tool with a motor housing (22a, 22b, 22c, 22d, 68) and a housing cover (26a, 26b, 26c, 26d, 72) that is attached to the motor housing (22a, 22b, 22c, 22d, 68).

It is provided that the portable power tool includes insulation means (44a, 44b, 44c, 44d, 70a, 70b) adjacent to the motor housing (22a, 22b, 22c, 22d, 68) and the housing cover (26a, 26b, 26c, 26d, 72), which are guided through a guide means (50a, 50b, 50c, 50d, 52a, 52b, 52d, 92) in the direction toward the motor housing (22a, 22b, 22c, 22d, 68) and/or the housing cover (26a, 26b, 26c, 26d, 72).

### RELATED ART

The present invention is directed to a hand-held power tool according to the definition of the species in claim 1.

Portable power tools are known that include a housing that includes a motor housing and a cup-shaped housing cover. The motor housing encloses internal components, e.g., an electric motor, and the cup-shaped housing cover encloses further electrical components, e.g., switches, power supply, etc. When the portable power tool is in the assembled state, the cup-shaped housing cover is attached to the motor housing in the axial direction of the housing cover. The housing is sealed by way of the fact that the housing cover and the motor housing bear against each other without play. This is made possible by designing the motor housing and the housing cover accordingly, and by using a press during assembly.

### ADVANTAGES OF THE INVENTION

The present invention relates to a portable power tool with a motor housing and a housing cover that is attached to the motor housing.

It is provided that the portable power tool includes insulation means, which are adjacent to the motor housing and the housing cover, and which are guided through a guide means in the direction toward the motor housing and/or the housing cover. Using the insulation means, an interior space enclosed by the housing can be insulated to the outside, and the formation of an electrical bridge composed, e.g., of metal and/or carbon dust, and extending from the motor to the operator's hand, can be effectively prevented, by way of which a high level of safety for the operator can be ensured. As an alternative, or in addition thereto, the housing cover and the motor housing can be insulated from each other, in order to minimize a transfer of vibrations from the motor housing to the housing cover. As a result, a high level of comfort for the operator can be attained. This insulation against vibrations, which can be attained via the selection of the design and/or material of the insulation means, is particularly suited for use, e.g., in sanders, in the case of which vibrations are produced, e.g., via imbalances in a rotating grinding disc.

Via the guide means, e.g., a stop element in the motor housing or in the housing cover, displacement of the insulation means in the axial direction in the motor housing or in the housing cover, e.g., when the housing cover is slid onto the motor housing, can be prevented. This prevents an undesired squeezing of the insulation means between the motor housing and the housing cover and, as a result, a poor seal.

The insulation means are preferably composed of an elastic material, such as an elastomer or a plastic, which is provided to dampen vibrations. Since the interior space can be sealed off from the outside by the insulation means, a great amount of assembly effort, e.g., adapting the housing cover exactly to the motor housing or using a press, can be avoided. The motor housing can be the part of the housing into which a motor of the portable power tool is inserted, e.g., during assembly.

A high level of comfort in operating the portable power tool can be attained when the housing cover is shaped like a cup and, in particular, when it is attached to the motor housing in the axial direction. An operator can guide the portable power tool primarily via the housing cover, and the housing cover can be damped well against vibrations that are caused by the motor and are transferred to the motor housing. The axial direction can be the axial direction of the cup-shaped housing cover. The insulation means are guided in the axial direction. The housing cover can be composed of one or more components; parts of a multiple-component housing cover can be installed laterally. The housing cover is preferably located on the side of the portable power tool opposite to a tool.

Advantageously, the guide means are part of a shoulder in the motor housing or in the housing cover. Via this configuration of the present invention, the insulation means can be installed on the guide means with a small amount of assembly effort. In addition, assembly errors, such as an undesired squeezing of the insulation means in a guide means designed, e.g., as a groove, can be prevented.

It is also provided that the insulation means are guided in the radial and axial directions via the interaction of motor housing and housing cover. Guidance errors can be prevented by way of these guide means. In addition, the insulation means can be positioned between the housing cover and the motor housing in a compact manner by adapting the design of the insulation means to the corresponding design of the motor housing and the housing cover.

In a further embodiment of the present invention, the insulation means include recesses. As a result, the insulation means can be connected, e.g., in the tangential direction, with the motor housing and/or the housing cover in a form-fit manner, which prevents the insulation means from rotating during operation of the portable power tool.

The portable power tool advantageously includes interior elements, which are located inside the motor housing and/or the housing cover, and which engage in the recesses. This makes it possible to design the insulation means with the interior components of the portable power tool, e.g., a carbon brush holder, to be compact, since the insulation means are adapted to the configuration of these interior components.

Advantageously, the insulation means are bonded with the motor housing or the housing cover. Assembly errors and a loss of the insulation means, e.g., during repair, can be prevented. The bond can be created by integrally extruding the insulation means onto the housing cover or the motor housing, or via gluing, soldering, welding or fusing.

In a further embodiment of the present invention, it is provided that the insulation means are manufactured with at least two parallel outer surfaces; in the installed state, at least one of these outer surfaces bears against the motor housing and the other outer surface bears against the housing cover. This design of the insulation means is suited, in particular, for damping the vibrations that are directed toward the outer surfaces at least largely perpendicularly, the vibrations being transferred from the motor housing to the housing cover.

It is also provided that the insulation means include at least one recess, which is formed in the axial direction. An efficient damping of vibrations oriented in the axial direction and in the radial direction can be attained, because the insulation means are highly flexible in the axial direction. In addition, the recess can serve as space into which the insulation means can expand in the axial direction.

A complete seal of the motor housing and the housing cover can be easily attained by the fact that the insulation means bear against the motor housing and the housing cover in a closed, annular manner.

The insulation means advantageously bear in an open, annular manner against the motor housing and the housing cover, and they include a gap, particularly in the radial direction. Due to the break in the annular insulation means, a high level of elasticity of the insulation means in the radial direction is attained; this makes it possible to use high levels of material hardnesses, e.g., polyamide, in the manufacture of the insulation means.

To attain a complete seal of the motor housing and the housing cover, the motor housing can include a rib, which is located in the gap.

In an advantageous refinement of the present invention, the insulation means—which have been preloaded in the radial direction—are mounted on the motor housing or the housing cover. The insulation means do not rest loosely against the motor housing or the housing cover. Instead, they exert pressure, via their own force, in the radial direction on the motor housing and/or the housing cover. Assembly errors and the loss of the insulation means, e.g., during repair, can be prevented as a result.

A further embodiment provides that the insulation means surround the housing cover or the motor housing in the shape of an L. By way of this form-fit connection, which is adapted to an edge, a shearing-off of the insulation means by the edge is prevented when the portable power tool is assembled, e.g., when the housing cover is slid onto the motor housing.

A stop is also provided, which prevents the insulation means from being compressed completely. In this manner, a “squishing” of the insulation means, which is located between the motor housing and the housing cover, is prevented, e.g., when the portable power tool is dropped and strikes an object.

### DRAWING

Further advantages result from the description of the drawing, below. Exemplary embodiments of the present invention are shown in the drawing. The drawing, the description and the claims contain numerous features in combination. One skilled in the art will also advantageously consider the features individually and combine them to form further reasonable combinations.

FIG. 1 shows a side view of an angle grinder with a motor housing, a housing cover, and an insulation means,

FIG. 2a shows an enlarged section of FIG. 1,

FIG. 2b shows alternative insulation means,

FIG. 2c shows further insulation means, which are bonded with the motor housing,

FIG. 2d shows further insulation means,

FIG. 3 shows an exploded view of part of an angle grinder with a motor housing, a housing cover, and an insulation means with a closed, annular configuration,

FIG. 4 shows a sectional view of section of the angle grinder in FIG. 3, in the assembled state, and

FIG. 5 shows insulation means with an open, annular configuration.

### DETAILED DESCRIPTION OF THE EXEMPLARY EMBODIMENTS

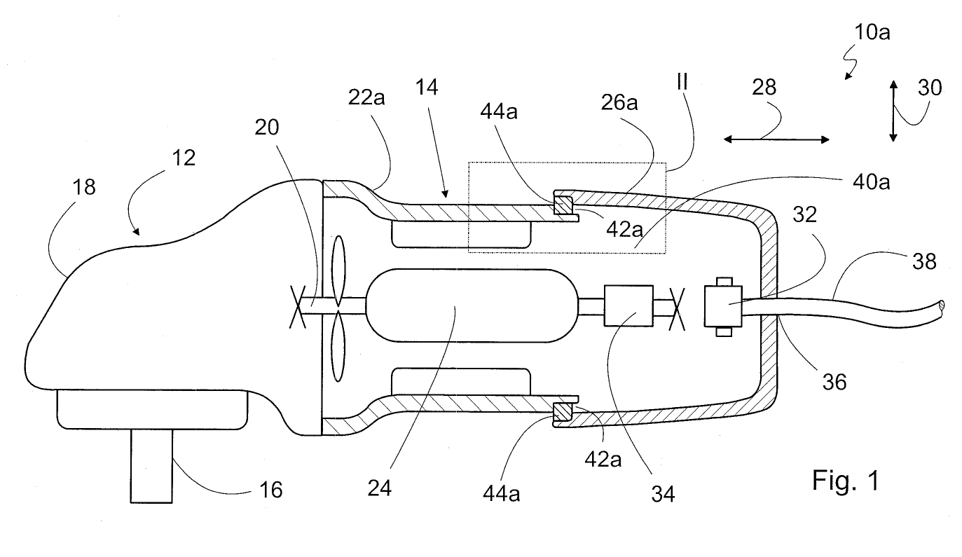

FIG. 1 shows a sectional view of an angle grinder 10a with a front part 12 and a rear part 14. Front part 12 includes an output shaft 16 and a gearbox housing 18, which encloses a transmission, which connects output shaft 16 with a motor shaft 20 and is not shown in the figure. A grinding disc designed to grind surfaces can be mounted on output shaft 16. Rear part 14 includes a motor housing 22a, which encloses an electric motor 24, and a cup-shaped housing cover 26a—with an axial direction 28 and a radial direction 30—which is mounted on motor housing 22a and covers a switch 32 and a carbon brush holder 34. A power cord 38 is guided through an opening 36 of housing cover 26a. Motor housing 22a and housing cover 26a enclose an interior space 40a. Insulation means 44a are located in a gap 42a between motor housing 22a and housing cover 26a, insulation means 44a bearing in a closed, annular manner against motor housing 22a and housing cover 26a. They insulate interior space 40a to the outside, and they insulate housing cover 26a against motor housing 22a.

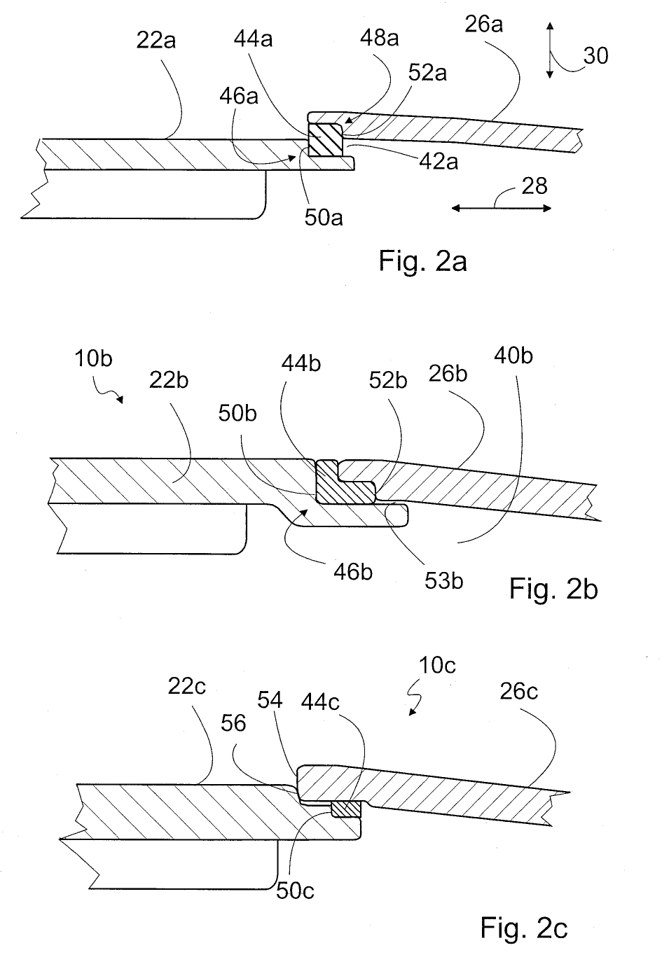

FIG. 2a shows an enlargement of section 11 in FIG. 1. Motor housing 22a and housing cover 26a each include a shoulder 46a and 48a, respectively. Insulation means 44a are guided in axial direction 28 by a guide means 50a in motor housing 22a and/or a further guide means 52a in housing cover 26a, both guide means 50a and 52a being designed as a section of shoulders 46a, 48a, respectively, which are oriented in radial direction 30.

During operation of angle grinder 10a, carbon dust can be produced in interior space 40a. In addition, metallic grinding dust can surround angle grinder 10a and be drawn by the motor fan into interior space 40a, where it deposits.

By way of insulation means 44a, which insulate interior space 40a to the outside in the region of gap 42a, gap 42a can be effectively prevented from filling with this dust, which also effectively prevents resultant electrical bridges from electric motor 24 to a hand of the operator, thereby ensuring safety. In addition, insulation means 44a can prevent an operator from experiencing vibrations in axial direction 28 and radial direction 30, the vibrations being transferred from motor housing 22a to housing cover 26a.

In a first step of assembling angle grinder 10a, insulation means 44a—which can be manufactured with a smaller inner diameter than the diameter of shoulder 46a and are subsequently preloaded in radial direction 30—are placed on shoulder 46a until they bear, in an annular manner, against guide means 50a. In a second assembly step, housing cover 26a is slid in axial direction 28 onto insulation means 44a, by way of which insulation means 44a bear in an annular manner against guide means 52a. Via the interaction of guide means 50a and 52a, an undesired squeezing of insulation means 44a between motor housing 22a and housing cover 26a, and a resultant poor sealing-off of interior space 40a, can be prevented in the second assembly step.

FIG. 2b shows a section of an alternative angle grinder 10b, which includes a motor housing 22b with a guide means 50b, a housing cover 26b with a guide means 52b, and an insulation means 44b. Housing cover 22b and motor housing 22b enclose an interior space 40b. Insulation means 44b surrounds housing cover 26b in the shape of an L, and they can be integrally extruded onto it. As a result, a shearing-off of insulation means 44b by an edge of housing cover 26b can be prevented when housing cover 26b is slid onto motor housing 22b. In addition, insulation means 44b are visible to an operator. As an alternative, insulation means 44b can be designed such that they surround motor housing 22b in the shape of an L. Insulation means 44b can be manufactured with a smaller inner diameter than the diameter of shoulder 46b and, in the installed state, they can exert pressure via their own force against motor housing 22b, which creates a good seal of interior space 40b to the outside. In addition, motor housing 22b and housing cover 26b form a gap 53b, the function of which is described with reference to FIG. 2d.

FIG. 2c shows a section of an alternative angle grinder 10c. Angle grinder 10c includes a motor housing 22c with guide means 50c, a housing cover 26c, and insulation means 44c, which are bonded with motor housing 22c. The bond can be created by integrally extruding insulation means 44c onto motor housing 22c, or via gluing or fusing. During assembly of angle grinder 10c, housing cover 26c is slid onto insulation means 44c until an end face 54 touches an edge 56 of motor housing 22c. When angle grinder 10c is disassembled, e.g., during repair, insulation means 44c remain adjacent to motor housing 22c due to the bond. This prevents insulation means 44c from becoming lost, and it prevents assembly errors from occurring when angle grinder 10c is assembled. As an alternative, insulation means 44c can be bonded with housing cover 26c.

FIG. 2d shows an alternative angle grinder 10d with a housing cover 26d, which includes guide means 52d, insulation means 44d, and a motor housing 22d, which includes guide means 50d and a stop 58 designed as a contact surface. Housing cover 26d and motor housing 22d enclose an interior space 40b. Housing cover 26d is fastened to interior elements 55d of angle grinder 10d by a screw 57d, which is screwed into a screw bearing 59d. Insulation means 44d are manufactured with a first outer surface 60 and a second outer surface 62, which is oriented parallel to first outer surface 60. In the assembled state of angle grinder 10d, outer surface 60 bears against housing cover 26d, and outer surface 62 bears against motor housing 22d. In addition, insulation means 44d are provided with several recesses 64 formed in axial direction 28.

During operation of angle grinder 10d, vibrations, which are transferred from motor housing 22d to housing cover 26d, can be damped by insulation means 44d. Vibrations that are oriented perpendicularly to outer surfaces 60 and 62 can be efficiently damped by a deformation of insulation means 44d, since space is provided for insulation means 44d—in the form of recesses 64—to deform in axial direction 28. Via recesses 64, great flexibility of insulation means 44d in axial direction 28 is also attained, which ensures efficient damping of vibrations oriented in axial direction 28. Insulation means 44d can bear, e.g., in a closed, annular manner, against motor housing 22d and housing cover 26d, which creates a good sealing-off of interior space 40d, or it can include several, separate segments, which creates additional installation space between the segments. In addition, vibrations that are transferred by interior elements 55d via screw bearing 59d and screw 57d to housing cover 26d can be damped via the selection of the material of screw bearing 59d, e.g., an elastic material. When high pressure is exerted from the outside in radial direction 30 onto housing cover 26d, e.g., when angle grinder 10d is dropped, stop 58—which is designed as a contact surface—prevents insulation means 44d from being completely compressed, since housing cover 26d strikes stop 58.

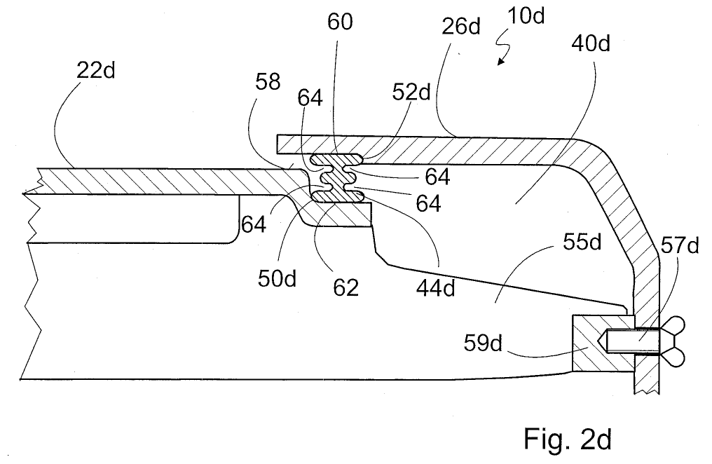

FIG. 3 shows an exploded view of a part of an angle grinder 66 that includes a motor housing 68, a closed, annular insulation means 70a made of hard rubber, and a cup-shaped housing cover 72 with an axial direction 74 and a radial direction 76; in the assembled state, cup-shaped housing cover 72 encloses interior elements 78. Interior elements 78 include a switch 80, a carbon brush holder 82, and walls 84. Motor housing 68 has an inner surface 86, which forms a shoulder with a projection 88. Insulation means 70a include several recesses 90a into which walls 84 engage when angle grinder 66 is in the assembled state. Housing cover 72 includes several guide means 92 designed as ribs, which are located on an interior side 94 of housing cover 72. Guide means 92 are displaced in axial direction 74 behind an inner edge 96 of housing cover 74 and extend to rear wall of housing cover 72. In addition, motor housing 68 and housing cover 72 enclose an interior space 98 when angle grinder 66 is in the assembled state.

In a first step of assembling angle grinder 66, insulation means 70a—which are manufactured with a larger outer diameter than the inner diameter of inner side 94 and which have been preloaded in radial direction 76—are inserted into housing cover 72. After insertion, insulation means 70a exert pressure via their own force onto housing cover 72. In a second assembly step, housing cover 72—with inserted insulation means 70a—is slid onto projection 88 until insulation means 70a touch the end face of projection 88 and are slid backward by it in axial direction 74 until they bear against guide means 92, which are designed as ribs.

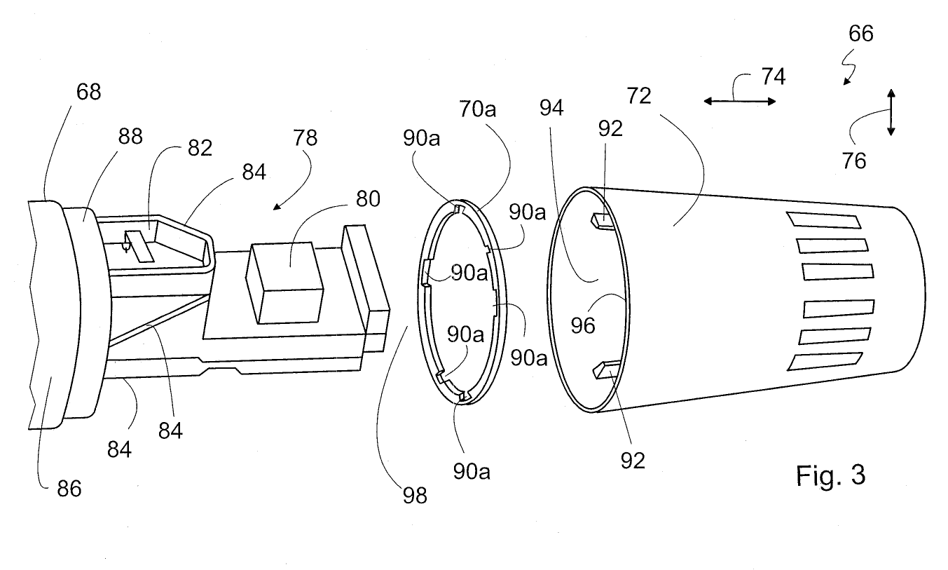

FIG. 4 shows a sectional view of a section of angle grinder 66 in the assembled state. Insulation means 70a bear against the end face of projection 88 and against guide means 92. By locating insulation means 70a in axial direction 74 behind projection 88, a compact design in radial direction 76 is ensured. Due to the preload, insulation means 70a remain in housing cover 72 when housing cover 72 is removed from motor housing 68, e.g., during repair, which can prevent insulation means 70a from becoming lost, and it can prevent assembly errors from being made when angle grinder 66 is assembled.

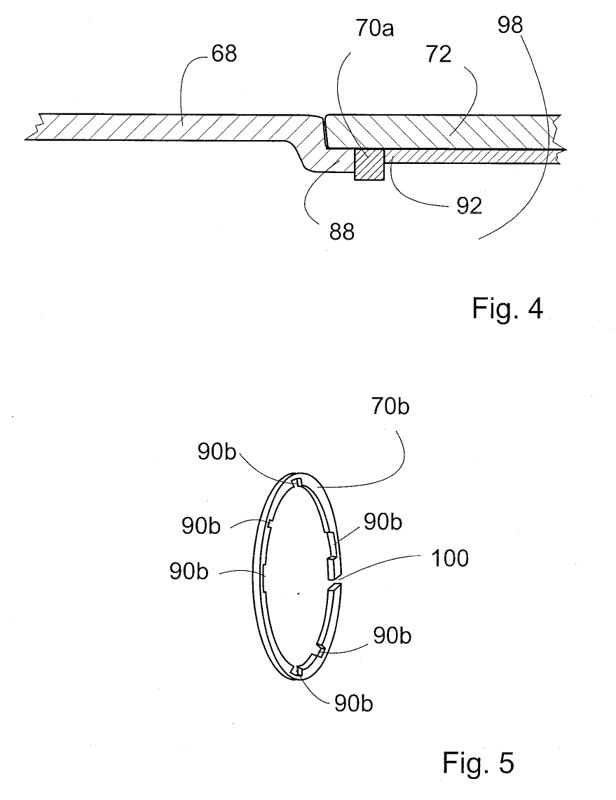

FIG. 5 shows alternative insulation means 70b, which include recesses 90b and a gap 100 in radial direction 76, and which are made of a harder material, e.g., polyamide, than insulation means 70a. Compared with insulation means 70a, insulation means 70b—due to gap 100—has a great deal of flexibility in radial direction 76. When angle grinder 66 is assembled—which is carried out as described for insulation means 70a—a rib (which is not shown in the figures) of angle grinder 66 also engages in gap 100. As a result, a high level of stability of insulation means 70b in assembled angle grinder 66 and a good seal of inner space 98 to the outside can be attained.

What is claimed is:

1. A portable power tool with a motor housing (22a, 22b, 22c, 22d, 68) and a housing cover (26a, 26b, 26c, 26d, 72) that is attached to the motor housing (22a, 22b, 22c, 22d, 68), characterized by insulation means (44a, 44b, 44c, 44d, 70a, 70b) adjacent to the motor housing (22a, 22b, 22c, 22d, 68) and the housing cover (26a, 26b, 26c, 26d, 72), which are guided through a guide means (50a, 50b, 50c, 50d, 52a, 52b, 52d, 92) in the direction toward the motor housing (22a, 22b, 22c, 22d, 68) and/or the housing cover (26a, 26b, 26c, 26d, 72).

2. The portable power tool as recited in claim 1,
wherein
the housing cover (26a, 26b, 26c, 26d, 72) is shaped like a cup and is attached to the motor housing (22a, 22b, 22c, 22d, 68) in the axial direction (28, 74) in particular.

3. The portable power tool as recited in claim 1,
wherein
the guide means (50a, 50b, 52a) are part of a shoulder (46a, 46b, 48a) in the motor housing (22a, 22b) or in the housing cover (26a).

4. The portable power tool as recited in claim 1,
wherein
the insulation means (70a, 70b) include recesses (90a, 90b).

5. The portable power tool as recited in claim 4, characterized by interior elements (78), which are located inside the motor housing (68) and/or the housing cover (72), and which engage in the recesses (90a, 90b).

6. The portable power tool as recited in claim 1,
wherein
the insulation means (44c) are bonded with the motor housing (22c) and/or the housing cover (26c).

7. The portable power tool as recited in claim 1,
wherein
the insulation means (44d) are manufactured with at least two parallel outer surfaces (60, 62); in the installed state, at least one of these outer surfaces (60, 62) bears against the motor housing (22d) and the other outer surface (60, 62) bears against the housing cover (26d).

8. The portable power tool as recited in claim 1,
wherein
the insulation means (44d) include at least one recess (64), which is formed in the axial direction (28).

9. The portable power tool as recited in claim 1,
wherein
the insulation means (70b) bear against the motor housing (68) and the housing cover (72) in an open, annular manner, and they include a gap (100), particularly in the radial direction (76).

10. The portable power tool as recited in claim 1,
wherein
the insulation means (44a, 44b, 70a, 70b), which have been preloaded in the radial direction (30, 76), are installed on the motor housing (22a, 22b, 68) or the housing cover (26a, 26b, 72).

11. The portable power tool as recited in
wherein
the insulation means (44b) surround the housing cover (26c) or the motor housing (22b) in the shape of an L.

12. The portable power tool as recited in claim 1, characterized by a stop (58), which prevents the insulation means (44d) from being compressed completely.
